(19) United States
(12) Patent Application Publication
(10) Pub. No.: US 2014/0210130 A1
(43) Pub. Date: Jul. 31, 2014

(54) MIXTURE FOR FORMING MOLDED PRODUCTS

(71) Applicant: William A. HIGBE, Prosperity, SC (US)

(72) Inventor: William A. HIGBE, Prosperity, SC (US)

(21) Appl. No.: 13/753,659

(22) Filed: Jan. 30, 2013

(51) Int. Cl. C04B 16/08

(52) U.S. Cl. CPC C04B 16/087
USPC 264/238; 521/146

(57) ABSTRACT

A mixture and method for forming molded products includes, in a preferred embodiment, Portland cement, shredded polystyrene, chopped fiberglass fibers, a waterproof coating agent, and water. These components may be mixed together, preferably in a large capacity mixer, to form a slurry, which may then be poured into a mold. The slurry is allowed to dry within the mold, and is then removed from the mold. The final product is a precast, molded item that is formed into a desired shape for use in the construction industry, and may be attached to a structure using screws, nails, adhesive, or any other suitable means of attachment.

### BACKGROUND OF THE INVENTION

The present invention relates generally to cementitious mixtures used for forming molded products. More specifically, the present invention relates to a cementitious mixture that may be used in the residential and commercial construction markets to form molded products, including decorative moldings used on external surfaces of buildings, as well as other types of molded products used inside homes and businesses. Such molded products may include, by way of non-limiting examples, crown molds, window casements, OG window seals (also commonly referred to as “Bullnose” window seals), fireplace mantles, balustrades, hand rails, keystones, column caps, etc. It should be understood that the present invention may be used to form any type of precast decorative item used with theses types of applications. The mixture set forth herein is particularly useful for manufacturing precast decorative items used on external faces of buildings having a stucco exterior.

In the past, decorative molding used in conjunction with stucco facades was formed from shaped Styrofoam (or polystyrene) having protective coatings applied to the outer surfaces thereof. These types of polystyrene-based products have a long and tortured history of causing problems in the construction industry, including water rot and deterioration, which can lead to similar problems with the underlying structure. Rot caused by moisture intrusion can lead to structural problems and attract insects and fungus that further damage the wood and the structural integrity of the building. Mold caused by moisture will not only damage the wood but also can lead to health problems for the occupants of a building. An additional problem created by improperly installed stucco and Styrofoam based molding is that the fiberglass or Styrofoam sheeting used in the system can create a pathway for termites to enter a structure by coming up into the building between the insulation and the wood substrate. Because the termites enter behind the insulation, the damage they cause can be severe before it even becomes noticeable.

Other types of cementitious mixtures have been developed for use in the construction industry. U.S. Pat. No. 5,580,378 is directed to a lightweight cementitious product made up of an aqueous cementitious mixture that can incorporate fly ash, portland cement, sand, lime, and the weight saving component, which is micronized polystyrene particles having particle sizes in the range of 50 to 2000 microns. The final mix can be poured. into molded products such as foundation walls, roof tiles, bricks and the like. The product can also be used as a mason's mortar, a plaster, a stucco or a texture.

U.S. Pat. No. 5,724,783 describes a wall building panel apparatus including a plurality of elongated panel frame members attached together to form a panel framework and having at least one stud attached between two panel frame members and having a panel side covering at least one side of the framework. A waste recycle aggregate material in a portland cement panel layer is formed in the panel to provide a prefabricated panel using waste recycle materials. A plurality of aggregate material and cement panel layers may be formed using recycled materials including used fiberglass insulation, recycled polystyrene, rubber tires, and old carpet material. The waste materials are converted to an aggregate through chopping, shredding, or with a hammer mill. A wall building process includes selecting waste recycling materials, such as used fiberglass insulation, used rubber tires, waste polystyrene, or waste carpet materials and converting the selected waste recycling materials into an aggregate material by chopping, shredding, or with a hammer mill. The aggregate is dampened. and coated with a coating mixture which includes Portland cement and microsilica. The coated aggregate recycling material is mixed with additional cement and sand and further mixed with additional cement and water and then placed into a building wall unit. The process includes placing the mixture in a plurality of layers with a wall panel, each layer including a different recycled material or combination of materials.

U.S. Pat. No. 5,622,556 is directed to a lightweight cementitious product made up of an aqueous cementitious mixture that can incorporate fly ash, portland cement, sand, lime, and the weight saving component, which is micronized polystyrene particles having particle sizes in the range of 50 to 2000 microns, and characterized by having very low water contents, in the range of from about 0.5% to 5% v/v. The ultra low water compositions can be extruded and can be molded under high pressure.

U.S. Pat. No. 5,352,390 describes fireproofing compositions. The compositions comprise a hydratable cementitious binder and polystyrene aggregate falling within particular particle size distribution limits. The compositions can also include an air entraining agent and a fibrous material. On addition of water, the compositions form settable, sprayable slurries which can be pumped to the point of application. The slurries are capable of spray application to steel structural members and adhere to the member in the slurried state and after setting. Excellent fire and heat protection is provided to the member despite the organic nature of the polystyrene aggregate.

### BRIEF SUMMARY OF THE INVENTION

In accordance with one aspect of the invention, a mixture for forming molded products includes, in a preferred embodiment, Portland cement, shredded polystyrene, chopped fiberglass fibers, a waterproof coating agent, and water. These components may be mixed together, preferably in a large capacity mixer, to form a slurry, which may then be poured into a mold. The slurry is allowed to dry within the mold, and is then removed from the mold. Coloring agents may also be included in the slurry, in order to obtain a desired color for the final product. After the molded product is removed from the mold, it may be pressure washed, in order to clean the final product, and to remove any shredded bits of polystyrene that may be exposed on an outer surface thereof.

The final product is a precast, molded item that is formed into a desired shape for use in the construction industry, such as crown molding, window casements, window seals, fireplace mantles, balustrades, hand rails, keystones, column caps, etc. The molded product may be attached to a structure using screws, nails, adhesive, or any other suitable means of attachment. The molded product is a strong, lightweight, water resistant product that overcomes many of the disadvantages of other similar products, particularly including Styrofoam based decorative moldings used in conjunction with stucco facades.

### BRIEF DESCRIPTION OF THE DRAWINGS

These and other features, aspects, and advantages of the present invention will become better understood with regard to the following description, appended claims, and accompanying drawings where:

FIG. 1 is a perspective view of one example of a precast, molded product in accordance with one aspect of the present invention;

FIG. 2 is a perspective view of one example of a precast, molded product in accordance with one aspect of the present invention;

FIG. 3 is a perspective view of one example of a precast, molded product in accordance with one aspect of the present invention; and

FIG. 4 is a perspective view of one example of a precast, molded product in accordance with one aspect of the present invention.

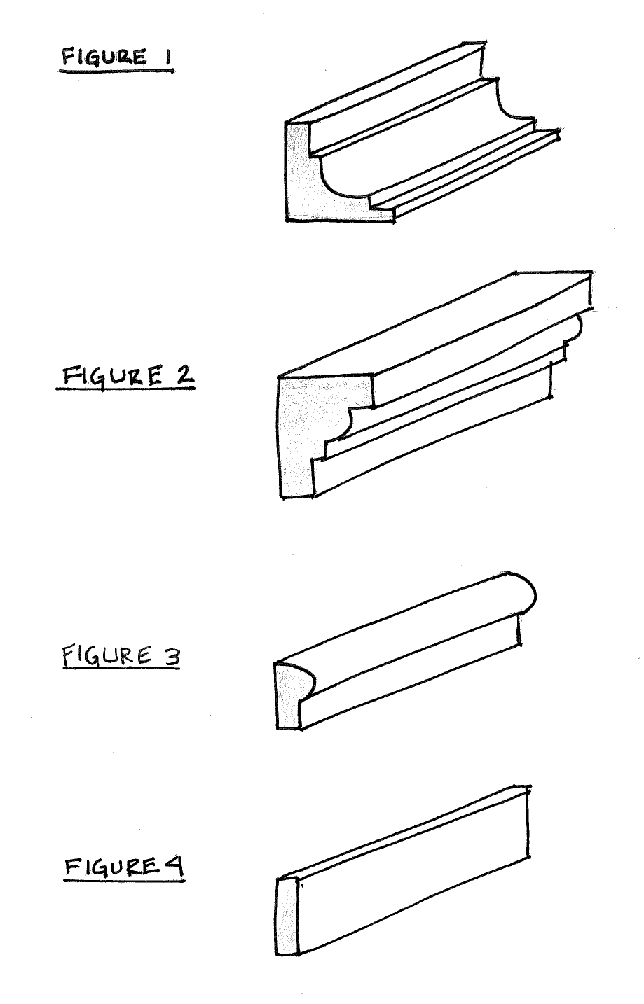

### DETAILED DESCRIPTION OF THE INVENTION

The present invention includes, in a first embodiment, a mixture for forming molded product, wherein a preferred embodiment includes the following components: a cementitious material (preferably Portland cement), shredded polystyrene, chopped fiberglass fibers, a waterproof coating agent, and water. It should be understood that certain components may have suitable substitute components. For instance, it may be possible to substitute shredded polyurethane or polyester for the shredded polystyrene in certain applications, and different types of waterproofing agents may be used to the same effect. In a preferred embodiment, the shredded polystyrene particles should be in the size range of 1/64 or 0.0156 inches to ⅛ or 0.125 inches, and should preferably be of irregular shape as a result of shredding, as opposed to the smooth, circular beads that are commonly used in beanbags, and the like. It is believed that the increased surface area of the irregularly shaped shredded polystyrene particles allows better adhesion with the cementitious material within the slurry. One preferred waterproofing agent is Tegraproof®, which is a crystalline capillary waterproofing agent for concrete manufactured by the chemical company BASF. In a preferred embodiment, the length of the chopped fiberglass should be between ½ inch and 2 inch, and Type I or Type II Portland cement is preferred.

In use, these components may be mixed together, preferably in a large capacity mixer, to form a slurry, which may then be poured into a mold. The slurry is allowed to dry within the mold, and is then removed from the mold. Coloring agents may also be included in the slurry, in order to obtain a desired color for the final product. After the molded product is removed from the mold, it may be pressure washed, in order to clean the final product, and to remove any shredded bits of polystyrene that may be exposed on an outer surface thereof.

The components should be mixed together in specific weight ratios, in order to obtain a final product with acceptable properties, such as strength and density. For example, the Portland cement should preferably comprise between about 45% and 75% by weight of the slurry, and more preferably, should comprise between about 52% and 70% by weight of the slurry. Similarly, the polystyrene should preferably comprise between about 1% and 3% of the slurry by weight, and more preferably between about 1.3% and 1.8% by weight of the slurry, the fiberglass should preferably comprise between about 0.1% and 1% by weight of the slurry, and more preferably between about 0.2% and 0.63% by weight of the slurry, the waterproofing agent should comprise between 0.5% and 2% by weight of the slurry, and more preferably between about 0.9% and 1.3% by weight of the slurry, and water should comprise between about 25% and 50% by weight of the slurry, and more preferably between about 28.5% and 45% by weight of the slurry.

Examples of slurry mixtures are provided in Examples 1-3.

### Example 1

94 pounds of Portland cement (or approximately 9 gallons by volume or 1504 ounces by weight) are mixed with 10 ounces of Tegraproof® waterproof coating agent, 4.25 ounces of chopped fiberglass, 10 gallons of shredded polystyrene and 5 gallons or 640 ounces of water to form a slurry.

### Example 2

94 pounds of Portland cement (or approximately 9 gallons by volume or 1504 ounces by weight) are mixed with 12 ounces of Tegraproof® waterproof coating agent, 6.75 ounces of chopped fiberglass, 15 gallons or 15 ounces by weight of shredded polystyrene and 4 gallons or 512 ounces of water to form a slurry.

### Example 3

94 pounds of Portland cement (or approximately 9 gallons by volume) are mixed with 14 ounces of Tegraproof® waterproof coating agent, 8 ounces of chopped fiberglass, 20 gallons of shredded polystyrene and 5 gallons or 640 ounces of water to form a slurry.

The Portland cement is used for strength, and the chopped fiberglass is used to assist in holding the molded product together. The shredded polystyrene is used as a light weight filler, and the waterproofing agent is included to reduce the amount of water that may soak into the final product under normal adverse weather conditions.

The final product is a precast, molded item that is formed into a desired shape for use in the construction industry, such as crown molding, window casements, window seals, fireplace mantles, balustrades, hand rails, keystones, column caps, etc. The molded product may be attached to a structure using screws, nails, adhesive, or any other suitable means of attachment. The molded product is a strong, lightweight, water resistant product that is resistant to crumbling when a screw or nail is driven through the material, so that these types of mechanical fasteners may be used to affix the molded product to a wall or the side of a house without destroying the molded product itself. The molded product is resistant to water rot, fire, insect damage and, because it includes a water resistant coating, tends to resist mold and mildew growth.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A slurry mixture for forming molded products, said slurry mixture comprising:
Portland cement;
shredded foam, wherein particles of said shredded foam have generally random, irregular shapes;
chopped fiberglass fibers;
a waterproof coating agent; and
water;
wherein said Portland cement, said shredded foam, said chopped fiberglass fibers, said waterproof coating agent and water are mixed together to form a generally uniform slurry.

2. The slurry mixture set forth in claim 1, wherein said Portland cement comprises between about 45% and 75% by weight of said slurry.

3. The slurry mixture set forth in claim 1, wherein said shredded foam comprises between about 1% and 3% by weight of said slurry.

4. The slurry mixture set forth in claim 1, wherein said chopped fiberglass fibers comprise between about 0.1% and 1% by weight of said slurry.

5. The slurry mixture set forth in claim 1, wherein said waterproof coating agent comprises between about 0.5% and 2% by weight of said slurry.

6. The slurry mixture set forth in claim 1, wherein said water comprises between about 25% and 50% by weight of said slurry.

7. The slurry mixture set forth in claim 1, wherein said chopped fiberglass fibers have a length in the range of about ½ inch to 1 ½ inch.

8. The slurry mixture set forth in claim 1, wherein said shredded foam comprises polystyrene.

9. The slurry mixture set forth in claim 1, wherein said shredded foam comprises a material selected from the group consisting of polyurethane and polyester.

10. The slurry mixture set forth in claim 1, wherein the shredded foam particles have sizes in the range between about 1/64 inches and ⅛ inches.

11. A method of forming a molded product for attachment to a structure, said method comprising the steps of:
providing a slurry comprising Portland cement, shredded foam having random, irregular shapes, chopped fiberglass fibers, a waterproofing agent and water;
mixing said slurry;
pouring said slurry into a mold;
allowing said slurry to dry within said mold and form a final molded product; and
removing said final molded product from said mold; and
attaching said final molded product to a structure.

12. The method set forth in claim 11, wherein said Portland cement comprises between about 45% and 75% by weight of said slurry.

13. The method set forth in claim 11, wherein said shredded foam comprises between about 1% and 3% by weight of said slurry.

14. The method set forth in claim 11, wherein said chopped fiberglass fibers comprise between about 0.1% and 1% by weight of said slurry.

15. The method set forth in claim 11, wherein said waterproofing agent comprises between about 0.5% and 2% by weight of said slurry.

16. The method set forth in claim 11, wherein said water comprises between about 25% and 50% by weight of said slurry.

17. The method set forth in claim 11, wherein said shredded foam is made from a material selected from the group consisting of polystyrene, polyurethane and polyester.

18. The method set forth in claim 11, wherein said chopped fiberglass fibers have a length range between about ½ inch and 1 ½ inch.

19. The method set forth in claim 11, wherein said waterproofing agent is a crystalline capillary waterproofing agent.

20. The method set forth in claim 11, wherein said shredded foam comprises particle sizes in a range of about 1/64 inches and ⅛ inches.
